(19) United States
(12) Patent Application Publication
(10) Pub. No.: US 2017/0193984 A1
(43) Pub. Date: Jul. 6, 2017

(54) TEXT TO SPEECH PAGING SYSTEM

(71) Applicant: NORTHFIELD TELECOMMUNICATIONS, INC., Lakeville, MN (US)

(72) Inventor: Kenneth J. Coons, Lakeville, MN (US)

(21) Appl. No.: 15/394,351

(22) Filed: Dec. 29, 2016

Related U.S. Application Data
(60) Provisional application No. 62/272,805, filed on Dec. 30, 2015.

(51) Int. Cl. G10L 13/08; G06F 3/16; H04W 4/12

(52) U.S. Cl. CPC G10L 13/08; H04W 4/12; G06F 3/16; G10L 2013/083

(57) ABSTRACT

A text-to-speech paging system can include a paging receiver, a text-to-speech module, an audio processing module, a radio transmitter, and a controller. The paging receiver can be configured to receive a radio-frequency text pager message from an industry-standard paging transmitter. The paging receiver can include a decoder configured to decode the radio-frequency text pager message to a decoded pager message. The text-to-speech module can be configured to convert the decoded pager message into audio information, and the audio processing module can be configured to process the audio information. The radio transmitter can be configured to receive the audio information from the audio processing module and transmit the audio information in an industry-standard two-way radio protocol. The controller can be configured to control the text to speech paging system.

### CROSS-REFERENCE TO RELATED APPLICATION

This application claims the benefit of U.S. Provisional Patent Application No. 62/272,805, filed on Dec. 30, 2015 and titled TEXT TO SPEECH PAGING SYSTEM.

### FIELD OF THE INVENTION

The present disclosure generally relates to a text to speech paging system for converting cryptic text to easily understood voice radio messages.

### BACKGROUND OF THE INVENTION

Senior communities in the United States commonly use paging systems to alert staff of various situations or tasks that need to be addressed. For example, text messages can be sent via page to a staff member, and a pager can beep or vibrate to alert the staff member of the new incoming text message. However, these paging systems can be intrusive and inefficient. For example, the paging systems can be intrusive for patients and their visitors because the beep or alert of a new message can interrupt conversation or quiet time. However, the pages can still be difficult for staff to manage, which can lead to an increased response time when reacting to an urgent situation. For example, a staff member may ignore a page or several staff members may inadvertently be sent the same alarm and response request. This can lead to several people responding or worse, no people responding.

The above complications are compounded by the fact that it is not possible for a staff member to reply back to the page to ask for clarification, communicate that the staff member is answering the call, or communicate other concerns, such as the fact that the staff member is unable to respond because he or she is currently helping a different patient or the fact that the staff member responding to the page may need additional assistance. The lack of two-way communication also results in increased response time and lack of accountability. Therefore, improvements to paging systems are needed that can supplement preexisting paging systems.

### SUMMARY OF THE INVENTION

The present disclosure relates to a text to speech paging system for converting cryptic text to easily understood voice radio messages. More specifically, the system can receive a text pager message from a paging transmitter, convert the message from text to speech, and broadcast the spoken message to a two-way radio. Furthermore, the system can send alerts to pre-defined channels and can enhance the messages by adding tones and making text string substitutions and deletions.

In an illustrative but non-limiting example, the disclosure provides a text-to-speech paging system that can include a paging receiver, a text-to-speech module, an audio processing module, a radio transmitter, and a controller. The paging receiver can be configured to receive a radio-frequency text pager message from an industry-standard paging transmitter. The paging receiver can include a decoder configured to decode the radio-frequency text pager message to a decoded pager message. The text-to-speech module can be configured to convert the decoded pager message into audio information, and the audio processing module can be configured to process the audio information. The radio transmitter can be configured to receive the audio information from the audio processing module and transmit the audio information in an industry-standard two-way radio protocol. The controller can be configured to control the text to speech paging system.

In some examples, the decoder can be a Post Office Code Standardization Advisory Group decoder.

In some examples, the decoded pager message can be transferred to the text-to-speech module as serial data.

In some examples, at least the text-to-speech module, the audio processing module, and the controller can be provided on a processing board. In some examples, the decoded pager message can be transferred from the decoder of the paging receiver to the processing board as serial data. In some examples, the audio information can be transferred from the processing board to the radio transmitter as serial data. In some examples, the text to speech paging system can be configurable by an external computer system communicatively coupled to the processing board.

In some examples, the system can further include an enclosure enclosing at least the paging receiver, the text-to-speech module, the audio processing module, the radio transmitter, and the controller. In some examples, the enclosure can be wall-mountable.

In some examples, the text-to-speech module can be configured to perform string substitutions. In some examples, the string substitutions can convert abbreviations in the decoded pager message into words.

In some examples, the radio transmitter can be configured to function with a carrier detect feature that can prevents transmission of audio information when a radio channel in use is not clear.

In some examples, the system can be configured to queue messages and transmit messages sequentially.

In another illustrative but non-limiting example, the disclosure provides a method for converting text-to-speech. The method can include a paging receiver receiving a radio-frequency text pager message from an industry-standard paging transmitter and the paging receiver decoding the radio-frequency text pager message to a decoded pager message. The method can further include a text-to-speech module converting the decoded pager message into audio information, an audio processing module processing the audio information, and a radio transmitter receiving the audio information from the audio processing module and transmitting the audio information in an industry-standard two-way radio protocol.

### BRIEF DESCRIPTION OF THE DRAWINGS

FIG. 1 illustrates a basic implementation of one embodiment of the disclosed invention.

FIG. 2 illustrates how the general components of one embodiment of the disclosed invention and interact with each other.

FIG. 3 illustrates the general components of one embodiment of the disclosed invention in more detail.

FIG. 4 illustrates a specific implementation of one embodiment of the disclosed invention.

FIG. 5 illustrates a specific implementation of one embodiment of the disclosed invention.

### DETAILED DESCRIPTION

The present disclosure relates to a text to speech paging system 100 that is used to clearly and efficiently enable hospital and senior community staff communication by converting cryptic text to easily understood voice radio message. Various embodiments of the text to speech paging system 100 will be described in detail with reference to the drawings, wherein like reference numerals represent like parts and assemblies throughout the several views. Reference to various embodiments does not limit the scope of the text to speech paging system 100 disclosed herein. Additionally, any examples set forth in this specification are not intended to be limiting and merely set forth some of the many possible embodiments for the text to speech paging system 100. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

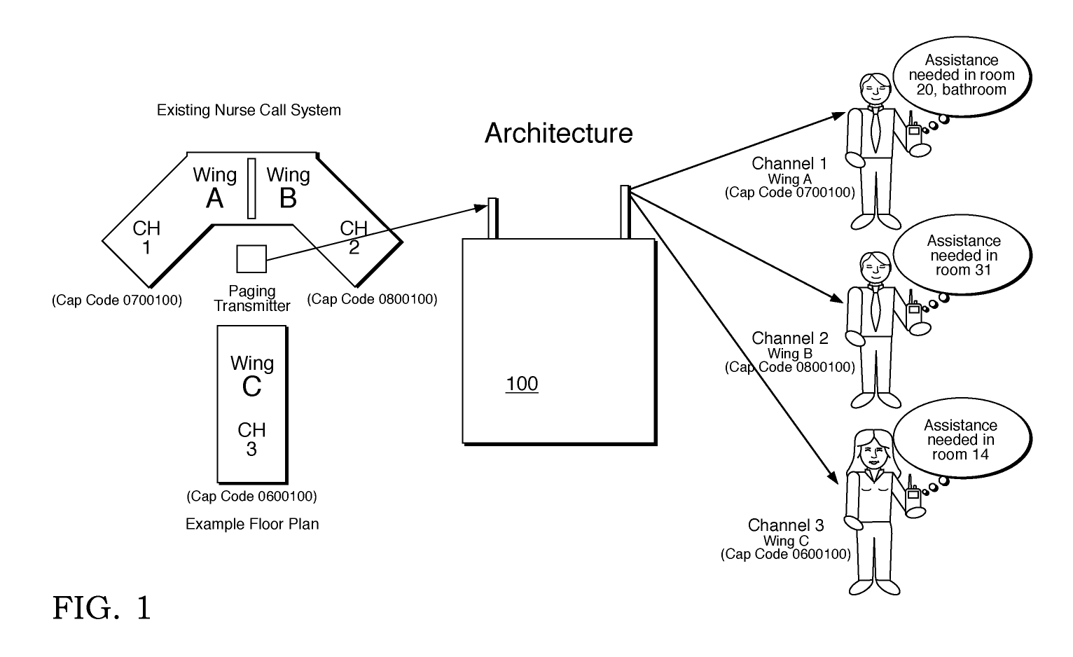

In general terms, the present disclosure relates to a text to speech paging system 100, illustrated in FIG. 1, used to clearly and efficiently enable hospital and senior community staff to communicate with each other by converting cryptic text to easily understood voice radio messages. More specifically, the disclosed text to speech paging system 100 can receive a page transmission and convert the page transmission text into an ultra high frequency (hereinafter “UHF”) radio message that may be steered to one or more pre-defined radio channels. The system 100 may enhance the spoken message by adding tones and making text string substitutions and deletions. In some embodiments, converted page text can be transmitted as a text message to a phone (for example, a Short Message Service [SMS] message, but not limited to the SMS protocol) and/or a radio (for example, using Frequency-Shift Keying [FSK], but not limited to the FSK scheme). Such text messages to phone and/or radio can be transmitted in addition, or as an alternative, to spoken radio messages.

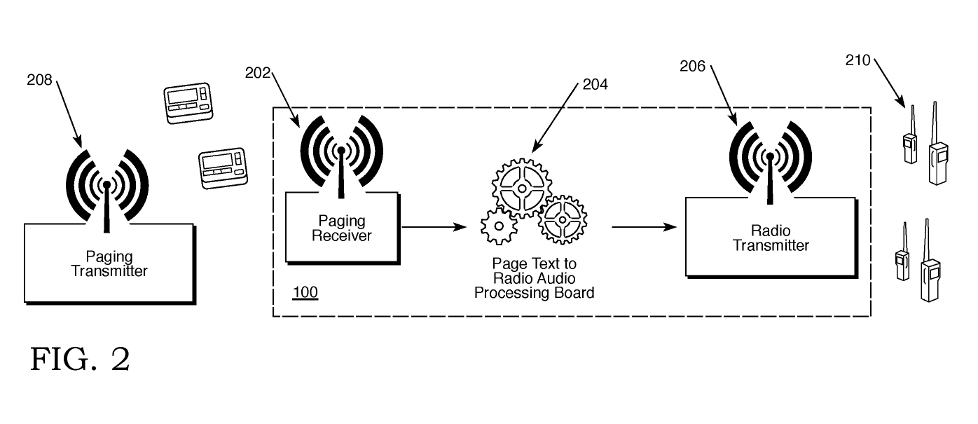

As illustrated in FIG. 2, various embodiments of the text to speech paging system 100 can include a number of components including, but not limited to, a paging receiver 202, a processing board or assembly 204, and a radio transmitter 206. In some embodiments, the functions disclosed herein as being performed by processing board 204 can be implemented on computer hardware such as a personal computer (PC). Generally, the paging receiver 202 receives all paging signals and pager messages from paging transmitters 208, which can be industry standard paging transmitters. The paging receiver 202 then decodes the pager messages and transmits the decoded pager message to the processing board 204, which converts the pager messages to speech. The processing board 204 then transmits the spoken message to the radio transmitter 206, which transmits the spoken message to specific two-way radios 210 using predetermined radio frequencies.

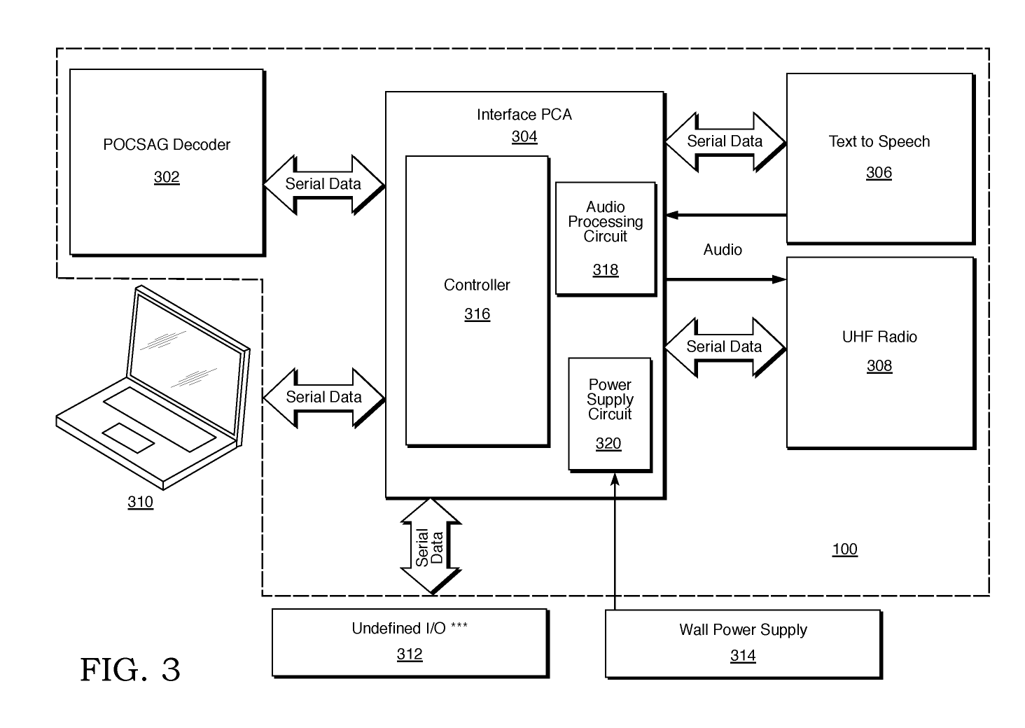

More specifically, as illustrated in FIG. 3, the paging receiver 202 can include a decoder 302, which can be a Post Office Code Standardization Advisory Group (hereinafter “POC SAG”) decoder, to decode the pager messages. The POC SAG decoder 302 can transmit and receive serial data to and from the processing board 204. The processing board 204 can include an interface printed circuit assembly (hereinafter “PCA”) 304 and a text-to-speech module 306, and it can interface with a computing device 310, an undefined input/output 312, and a wall power supply 314. The interface PCA 304 can include a controller 316, an audio processing circuit or module 318, and a power supply circuit 320. The interface PCA 304 can communicate with the text-to-speech module 306 by transmitting and receiving serial data. The text-to-speech module 306 can convert the pager message to speech and transfer the converted pager message back to the interface PCA 304. The interface PCA 304 can then transmit the converted pager message to the UHF radio transmitter 308, which transmits the message to a two-way radio 210. The staff members can then communicate with each other on the two-way radios to determine, for example, who is answering the page, whether that staff member needs additional help, or whether a staff member is unavailable to assist.

In some embodiments, the text-to-speech module 306 can be provided as a discrete component on processing board 204. In some other embodiments, the text-to-speech module 306 can be implemented on computer hardware such as a PC. In some embodiments, the audio processing module 318 can be provided as a discrete component on processing board 204. In some other embodiments, the audio processing module 318 can be implemented on computer hardware such as a PC.

The paging receiver 202, which receives pager messages, can be programmed with a predefined paging frequency range. In some embodiments, the frequency ranges from 450-460 MHz. In other embodiments, the frequency ranges from 460-470 MHz. Each pager can have a specific identification sequence, such as a Channel Access Protocol (hereinafter “CAP”) code, that identifies the pager. The POC SAG decoder 302 in the paging receiver 202 can be set up to intercept messages from all pagers that have CAP codes falling within a predefined range of contiguously number codes, such as 100 and up.

In some embodiments, the number given for the CAP code is seven digits and is padded with 0's. To enable the system to recognize the pagers, the CAP codes for the designated pagers can be written into the processing board 204 using a configured file. The text-to-speech module 306, which can be installed on, for example, a Windows operating system, can be used to do this. Each CAP code can be associated with a radio channel (ex: channels one through eight) in the system 100 and can be separated by spaces, before and after it in the pager message, from the user's system. More than one CAP code can be associated with each radio channel. In some embodiments, the number of inputs “CAP codes to Channel” can be set to a default number, such as 16, but can be configured to include more. To change a CAP code setting, a user can configure the module by activating the text-to-speech software module 306.

To configure the paging receiver 202, software and a programming cable 506, such as an RS232 null modem cable, can be used to connect the computing device 310 to the paging receiver 202. This connection may also be used to monitor existing pager messages using a terminal program. The settings for this port can vary and, in some embodiments, can be 9600 baud, parity none, and one stop bit. In a preferred embodiment, the text-to-speech software module 306 can interface to the cable 506 connected to the processing board 204 to show the CAP codes and the formatting of the text strings.

The system 100 can take abbreviations used in the text of pager messages and convert them into full words when transmitted to the two-way radio 210. Therefore, defined text may be changed to words or phrases, which can be natural language words or phrases. This task can be accomplished with the text-to-speech module 306 using a string substitution. For example, a text of “Bth Rm 201” could be converted to “Bath Room 201.” In some embodiments, the system 100 can leave out a word that the user does not want spoken if quotations surround the word. The system 100 can then say exactly what is on the paging text. In some embodiments, symbols such as an asterisk, ampersands, and pound signs are ignored while others such as quotations, commas, question marks, and exclamation points may be interpreted and may be used to enhance the statement's sound. In some embodiments, the system 100 is configured to contain approximately 25 substitutions, but is adjustable to increase the number of available substitutions. Further, different voices, volume, and message repeats ranging from 1 (i.e., no repeat) to 5 can be configured into the file.

In some embodiments, tones may be sent out prior to a radio message by inserting a caret sign or pound sign into the beginning of a message ahead of the rest of the text. For example, if the pager text is “help is needed in bathroom 201” and a user wants to insert tones prior to the radio message, the user can enter a substitution such as “\hat{0}2 bathroom.” The radio message can then transmit as “(Beep) (Beep) (Beep) help is needed in bathroom 201.” The number following the caret or pound sign can indicate which one of a plurality of tones the user wishes to insert prior to the radio message.

As described above, the radio transmitter 206 can be a UHF radio transceiver 308 that is used to transmit the spoken message to one or more two-way radios. It can have a carrier detect that prohibits the processing board 204 from transmitting until a radio channel in use is clear, such that audio information (e.g., the spoken message) is not transmitted when the channel is not clear. In some embodiments, the system 100 can transmit multiple messages sequentially and can queue more than 50 radio messages if need be.

The radio's channel setup can be programmed before installation. While the default power can be two watts, power up to four watts can be programmed into the system 100. Due to potential interference issues, in a preferred embodiment the radio antenna can be at least 16 feet away from the paging receiver's antenna. To further decrease potential interference, the text-to- speech module 306 can be positioned close to the paging transmitter 208. In a preferred embodiment, the wall power supply 314 can supply 12 volts DC at 4.2 amps to the system 100.

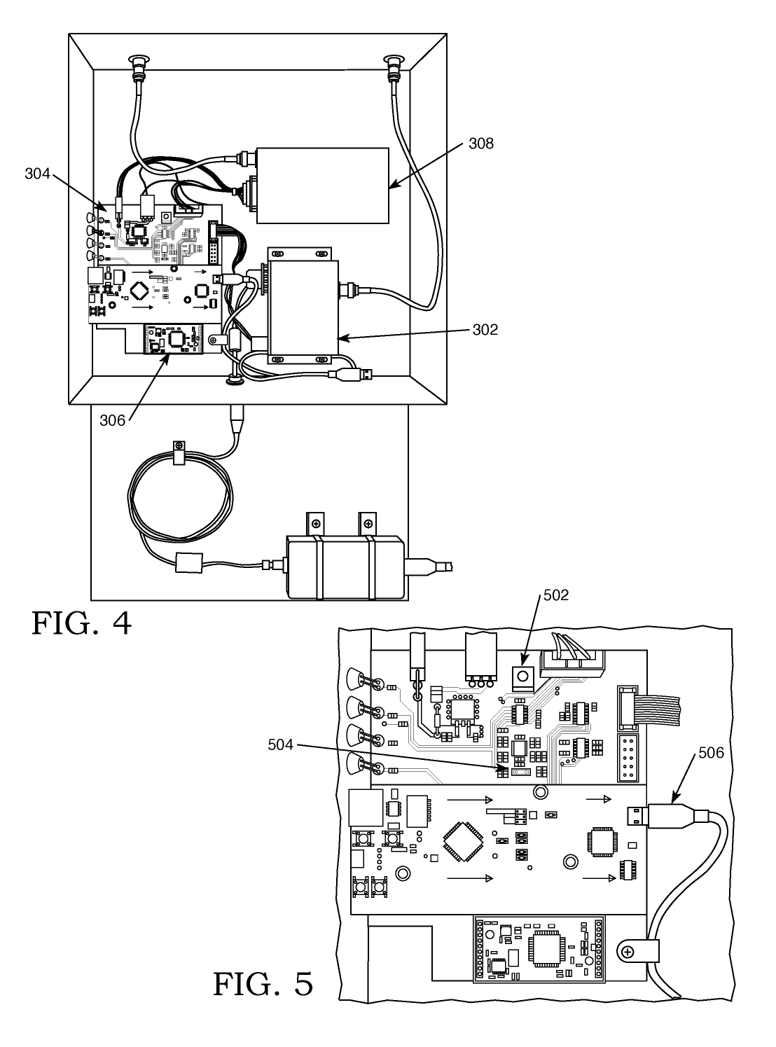

The system 100, one embodiment of which is illustrated in FIG. 4, can have four LED lights that act as indicators. One LED light, the Transmitter LED, can indicate when the radio transmitter 206 is keyed. A second LED light, the Carrier Detect LED, can indicate that a radio channel is busy. The radio transmittal 206 can wait for the channel to clear before it transmits and, if it is busy, the processing board 204 can queue up to 50 radio messages that can all transmit once the channel is clear. A third LED light, the Power LED, can indicate when the text-to-speech module 306 is powered on. A fourth LED light, the Page Received LED, can indicate when the paging receiver 202 receives a programmed CAP code. The LED indicator lights can communicate a successful page to radio transmission by first flashing a red LED light on the paging receiver 202. The red LED light can flash for any page if the POCSAG decoder 302 matches the system's paging transmitter frequency. Next, several actions can occur simultaneously or in quick succession: the Page Received LED can light for a second if the CAP code is recognized, the blue LED on the text-to-speech module 306 can blink, the Transmit LED can light on the processing board 204 along with the transmit light on the radio transmitter 206, and a blue LED on the text-to-speech module 306 can light up when it is converting text to audio. Lastly the LED on the UHF radio transmitter 308 can light up and a message can be heard on the two-way radio 210. If the message volume is too low, the Transmission Audio Volume Pot 502 on the processing board 204 may be adjusted, as illustrated in FIG. 5. Additionally, a transmission audio companding jumper 504 can be located on the processing board 204 to change the transmit audio to companded or non-companded, as illustrated in FIG. 5.

The LED indicator lights can also alert a user that the system 100 is on. For example, when power is applied, the Power LED, processing board, paging receiver, and radio transmitter can briefly flash. The text to speech module's red LED lights and the blue LED can flash once as well. Then, thirty seconds later, the blue LED can flash again, thereby indicating that the system 100 is ready.

What is claimed is:

1. A text-to-speech paging system, comprising:
a paging receiver configured to receive a radio-frequency text pager message from an industry-standard paging transmitter, the paging receiver having a decoder configured to decode the radio-frequency text pager message to a decoded pager message;
a text-to-speech module configured to convert the decoded pager message into audio information;
an audio processing module configured to process the audio information;
a radio transmitter configured to receive the audio information from the audio processing module and transmit the audio information in an industry-standard two-way radio protocol; and
a controller configured to control the text to speech paging system.

2. The system of claim 1, wherein the decoder is a Post Office Code Standardization Advisory Group decoder.

3. The system of claim 1, wherein the decoded pager message is transferred to the text-to-speech module as serial data.

4. The system of claim 1, wherein at least the text-to-speech module, the audio processing module, and the controller are provided on a processing board.

5. The system of claim 4, wherein the decoded pager message is transferred from the decoder of the paging receiver to the processing board as serial data.

6. The system of claim 4, wherein the audio information is transferred from the processing board to the radio transmitter as serial data.

7. The system of claim 4, wherein the text to speech paging system is configurable by an external computer system communicatively coupled to the processing board.

8. The system of claim 1, further comprising an enclosure enclosing at least the paging receiver, the text-to-speech module, the audio processing module, the radio transmitter, and the controller.

9. The system of claim 8, wherein the enclosure is wall-mountable.

10. The system of claim 8, wherein the text-to-speech module is configured to perform string substitutions.

11. The system of claim 10, wherein the string substitutions can convert abbreviations in the decoded pager message into words.

12. The system of claim 1, wherein the radio transmitter is configured to function with a carrier detect feature that prevents transmission of audio information when a radio channel in use is not clear.

13. The system of claim 1, wherein the system is configured to queue messages and transmit messages sequentially.

14. A method for converting text-to-speech, comprising:
a paging receiver receiving a radio-frequency text pager message from an industry- standard paging transmitter
the paging receiver decoding the radio-frequency text pager message to a decoded pager message;
a text-to-speech module converting the decoded pager message into audio information;
an audio processing module processing the audio information;
a radio transmitter receiving the audio information from the audio processing module and transmitting the audio information in an industry-standard two-way radio protocol.
